(19) United States
(12) Patent Application Publication
(10) Pub. No.: US 2024/0339768 A1
(43) Pub. Date: Oct. 10, 2024

(54) CONDUCTOR CONNECTION TERMINAL

(71) Applicant: WAGO Verwaltungsgesellschaft mbH, Minden (DE)

(72) Inventor: Michael MEYER, Wiedensahl (DE)

(73) Assignee: WAGO Verwaltungsgesellschaft mbH, Minden (DE)

(21) Appl. No.: 18/744,558

(22) Filed: Jun. 14, 2024

Related U.S. Application Data
(63) Continuation of application No. PCT/EP2022/085583, filed on Dec. 13, 2022.

(30) Foreign Application Priority Data
Dec. 20, 2021 (DE) 10 2021 133 884.0

(51) Int. Cl. H01R 4/48

(52) U.S. Cl. CPC H01R 4/4811

(57) ABSTRACT

A conductor connection terminal having a spring-loaded clamping connection that has a clamping spring and a busbar. An electrical conductor can be clamped under spring force to a conductor-connection side of the busbar by a clamping leg of the clamping spring. The conductor connection terminal has a support element having a support portion for bearing against a side of the busbar, which side is remote from the conductor-connection side. Thus, provided is a compact and versatile conductor connection terminal that is further improved in terms of its functionality and overall size. This aim is achieved in that the support element has a spring tongue via which an electrical contact element can be clamped to the busbar under spring force. As a result, an additional connection option is provided without an additional separate connection component, without increasing the overall size of the conductor connection terminal.

This nonprovisional application is a continuation of International Application No. PCT/EP2022/085583, which was filed on Dec. 13, 2022, and which claims priority to German Patent Application No. 10 2021 133 884.0, which was filed in Germany on Dec. 20, 2021, and which are both herein incorporated by reference.

### BACKGROUND OF THE INVENTION

### Field of the Invention

The invention relates to a conductor connection terminal comprising a spring-loaded clamping connection that has a clamping spring and a busbar, wherein an electrical conductor can be clamped under spring force to a conductor-connection side of the busbar by means of a clamping leg of the clamping spring, and having a support element comprising a support portion for bearing against a side of the busbar which side is remote from the conductor-connection side.

### Description of the Background Art

Conductor connection terminals comprising a spring-loaded clamping connection that has a clamping spring for clamping an electrical conductor to a busbar are state-of-the-art. Conductor connection terminals are continuously being further developed to reduce size and production costs. In order to improve the stability of conductor connection terminals in small dimensions, technical solutions have been introduced in the past in which a support element is attached to the busbar or the busbar bears against a support element in order to mechanically stabilize the busbar.

### SUMMARY OF THE INVENTION

It is therefore an object of the invention to further optimize a conductor connection terminal in terms of its functionality and overall size and to provide a compact, versatile conductor connection terminal.

In the case of the generic conductor connection terminal, it is proposed that the support element has a spring tongue by means of which an electrical contact element can be clamped to the busbar under spring force.

As a result, an additional connection option is provided without increasing the overall size of the conductor connection terminal. Also, no additional separate components are required for further connection and the required clearance and creepage distances are not reduced. A functional extension of the conductor connection terminal is made possible by means of a generic component that already exists, namely the support element. This further optimizes the functionality and overall size of the conductor connection terminal, making it particularly compact and versatile.

The support element can be arranged with a support portion adjacent to the busbar. The support element can contact the busbar surface at least in sections. It is conceivable that the busbar is supported on the support portion of the support element in order to be able to better absorb the spring forces of the clamping spring acting on the busbar.

The spring tongue can, for example, protrude from the support element. The spring tongue can connect to the support portion and protrude from the support portion. In addition to a clamping point formed between the clamping spring and the busbar, the spring tongue can form a further clamping point with the busbar, at which an electrical contact element can be clamped to the busbar under spring force by means of the spring tongue of the support element.

The conductor-connection side of the busbar can be the side of the busbar, which is beam-like, for example, and which faces the clamping spring and to which the clamping leg of the clamping spring points. The side of the busbar remote from the conductor-connection side may be the rear side opposite the conductor-connection side (in this application hereinafter also referred to as bottom) of the busbar on which there is no clamping leg of the clamping spring. The support element can thus be adjacent to the busbar on a side of the busbar remote from the clamping spring.

A spring tongue can be understood to be an elastically movable, flap-shaped spring element that can have one or more curvatures or angulations and exert a spring force in the direction of the busbar on a contact element inserted into the conductor connection terminal and contacted by the spring tongue. For example, the spring tongue can be connected at one end to the support element and have a free end with an end region.

An electrical contact element can be, for example, a contact pin, a stripped conductor wire or even the plug-in tongue of a jumper.

The spring tongue may have a resilient bend with a protruding clamping arm for clamping the electrical contact element.

The resilient bend can be, for example, an angulation or bend of the spring tongue with an angle or radius, so that the spring tongue in its course, for example starting from the support element in the direction of a free end of the spring tongue, changes the direction of its main extension. In this case, a section of the spring tongue between the resilient bend and the free end of the spring tongue can form the clamping arm of the spring tongue, wherein the clamping arm exerts a spring force on the contact element to be clamped or clamped to the busbar. By means of the resilient bend, the spring tongue can be adjusted in such a way so that the clamping arm of the spring tongue is aligned towards the busbar.

By means of a clamping arm of the spring tongue protruding from a resilient bend, the clamping force of the spring tongue exerted on a contact element to be clamped or clamped can be increased and the available installation space can be better utilized because the bending reduces the space required by the spring tongue.

The spring tongue can be bent in an S-shape, at least in sections.

For example, the resilient bend mentioned above can describe part of the S curve. A further angulation or bending of the spring tongue can be directly attached to a connection area of the spring tongue with the support element, so that the spring tongue protrudes at an angle or radius from the support element. Alternatively or additionally, there may be a further angulation or bend on a clamping arm of the spring tongue to provide an angle or radius at the clamping point of the spring tongue and thus increase the clamping force on a connected contact element. There may be an angle or bend at an end area of the spring tongue so the rounding can facilitate insertion of the contact element. There may also be multiple bends or angles in the spring tongue and the spring tongue can, for example, have an alternating convex and concave course. The S-shaped bend, at least in sections, as well as optionally further bends or angles, can optimize the use of the installation space in the conductor connection terminal in the area of the spring tongue.

The electrical contact element can be clamped to a contact connection side on the busbar.

For example, the contact connection side can be located on the side of the busbar remote from the conductor-connection side. In this way, the busbar is used by two different sides opposite each other, making optimal use of the available installation space.

However, it is also conceivable that the contact connection side is located on another side of the busbar, for example on the conductor-connection side, or on another side such as a front side of the busbar. To do this, the spring tongue only has to be designed accordingly so that it can form another clamping point, in addition to the conductor connection terminal, for the contact element on the desired side of the busbar.

Specific sides of the busbar do not necessarily imply an assignment of a respective surface of the busbar to one side. It is conceivable that a specific surface of the busbar may extend partly on one side, for example the conductor-connection side of the busbar, and partly on another side, for example the side of the busbar remote from the conductor-connection side. For example, the busbar can be bent or angled, so that a surface of the busbar is deflected from one side of the busbar to another side. It is therefore conceivable that an electrical conductor clamped by the clamping spring and an electrical contact element clamped with the spring tongue can be clamped on different sides but on the same clamping surface of the busbar. The side of the busbar on which an electrical contact element is clampable or clamped is called the contact-connection side.

The spring tongue may extend substantially from the support element against the insertion direction of the electrical contact element to be clamped to the busbar.

The spring tongue can extend essentially parallel to an inserted and clamped electrical conductor. The spring tongue can first extend in sections from the support element transversely to a plug-in direction of the electrical contact element and then merge via a resilient bend in the extension opposite a contact element to be inserted. It is also possible that the spring tongue extends at least in sections substantially parallel to the busbar or at an angle to the busbar.

The plug-in plane of an electrical conductor that can be clamped to the busbar can run essentially parallel to the plug-in plane of a contact element that can be clamped to the busbar.

The contact element and the electrical conductor can thus be inserted into the conductor connection terminal in essentially parallel planes. This makes it easy and convenient to connect a conductor and a contact element to the conductor connection terminal and the available installation space is used efficiently. The insertion directions of a conductor to be inserted and a contact element to be inserted can be aligned.

The spring tongue can be designed in one piece with the support element, so that an integral design of the spring tongue and support element with each other is provided.

The spring tongue can be connected to the support element by a form, force or material connection or a separate fastener. The support element can have a solid base body or, for example, a side section bent away from the support portion of the support element, which stabilizes the support element in a material-saving way.

The support element can be a sheet metal machined in the stamping and bending process with one or more stamped, bent spring tongues. Alternatively or additionally, the sheet metal forming the support element that has been machined in the stamping and bending process, can have one or more stamped and bent side sections. The one-piece design of the spring tongue with the support element makes it easy to manufacture and assemble the conductor connection terminal with high stability and long service life of the conductor connection terminal components.

The spring tongue may have a bearing section for the spring tongue to bear against a side section of the support element.

The spring tongue can have a bearing section for the spring tongue to bear against a base body of the support element. By attaching the spring tongue to the support element, improved stability of the conductor connection terminal and a higher spring force of the spring tongue can be achieved.

The bearing section of the spring tongue can be a part of a resilient bend of the spring tongue or merge into the resilient bend. It is also conceivable that the bearing section of the spring tongue is a section of the spring tongue between a connection point with the support element and a resilient bend of the spring tongue.

The spring tongue can be attached to the bearing section, for example, on an edge of the side section or on a side surface of the base body of the support element. The bearing section does not have to contact the side section or the base body continuously, depending on the condition of the conductor connection terminal. A permanent attachment is therefore not mandatory.

The spring tongue can only engage with the base body of the support element when an electrical contact element is inserted. The spring tongue can support itself in its bearing section against the side section or base body of the support element, so that improved force absorption occurs. In addition, for example, a resilient bend connected to the bearing section can provide a favorable angulation of the spring tongue towards the busbar with a resulting greater spring force.

The areas of the support element may be arranged one after the other in the following order from the inside to the outside: Starting from a support portion of the support element, a spring tongue protrudes from it at a connecting point. A bearing section connects to the connecting point (possibly via a transition section) with which the spring tongue can attach itself or be attached to a side section of the support element arranged below the bearing section.

The bearing section of the spring tongue can merge into a resilient bend from which a clamping arm protrudes towards the busbar. The clamping arm can transition, for example, at a clamping point with the busbar to a bent tongue end for ease of insertion.

The bearing section can form a stop to limit the insertion depth of the electrical contact element.

The contact element may then, for example, hit the bearing section with a contact element tip during insertion and not be further inserted towards the side section or the base body of the support element. The spring tongue may form a receiving space or a receiving pocket for the electrical contact element. The stop or the receiving space ensures a controlled and safe insertion process for the electrical contact element.

The busbar may be bent in an end section towards the spring tongue.

The busbar can be designed with a bend between 90° and 270° or between 120° and 240° or between 150° and 210°. The busbar thus has a busbar bend in one end section.

The busbar bend can form a clamping point for the electrical contact element with the spring tongue. The clamping point of the spring tongue for the electrical contact element can be formed on the same clamping surface of the busbar as the clamping point of the clamping spring for the electrical conductor. The busbar bend provides a structurally simple and material-saving solution for arranging the spring tongue and the busbar close to each other, so that the spring force of the spring tongue at the clamping point is greater than with a non-bent busbar.

The busbar can essentially be shaped like a beam. The busbar may have a side plate, wherein the side plate is bent away from the busbar, for example.

The busbar can have two side plates. An attachment leg of the clamping spring can extend between the side plates.

The busbar can have a guide for partially accommodating a bearing leg of the clamping spring, wherein the guide is present in a bent side plate of the busbar.

The busbar may have an inclined section in the area of the clamping point intended for clamping an electrical conductor with the clamping spring, wherein the inclined section partially protrudes from the busbar, for example, or is reinforced. The inclination improves the insertion and contacting of an electrical conductor clamped with the clamping spring.

The busbar can be designed in one piece. For example, the busbar is a piece of metal machined in the stamping and bending process with a stamped and bent side plate and/or with a busbar bend.

An attachment leg of the clamping spring can protrude into or through an opening in the busbar with an end segment.

The attachment leg can also protrude with the end segment into a recess in the support element. In these examples, a specifically extended attachment leg of the clamping spring that protrudes into an opening of the busbar and, if necessary, a recess of the support element is used to center, fix and stabilize the components of the conductor connection terminal. The recess can be a T-shaped cut-out in the support element. This allows for the attachment leg to be locked in the support element.

The conductor connection terminal can be installed as a double or multiple connection with at least two conductor insertion openings opposite each other and with at least two clamping springs, at least one busbar and at least one support element.

Conductors can be inserted into the conductor connection terminal from two opposite sides of the conductor connection terminal in opposite insertion directions through two opposing conductor insertion openings. The conductor connection terminal can be a connecting terminal for connecting two electrical conductors together. The at least two clamping springs can be arranged opposite each other. One attachment leg of a clamping spring can be attached to one attachment leg of a second clamping spring so that the attachment legs support each other.

The double or multiple connection can have a mirror-symmetrical structure, the axis of symmetry of which runs between the opposing clamping springs, for example between adjacent attachment legs of the clamping springs or their end segments.

A continuous common busbar may be provided for the clamping springs. However, it is also conceivable that separate busbars are provided for each clamping spring.

A common support element for the busbar or the busbars with a common support portion may be provided. However, it is also conceivable that alternatively several support elements are provided for the busbar or the busbars, each with a separate support portion. In the case of a common support element, spring tongues can protrude from opposite sides of the support element, with each of which an electrical contact element can be clamped in place on the busbar under spring force. The conductor connection terminal may have opposing contact element insertion openings.

If the conductor connection terminal is designed as a double or multiple connection, components of the conductor connection terminal such as the busbar or the support element can be used to connect several electrical conductors and electrical contact elements, so that the functionality and the use of the installation space of the spring connection terminal are improved.

The conductor connection terminal block may be designed as a double or multiple terminal blocks with at least two conductor insertion openings arranged next to each other and with at least one clamping spring, at least one busbar and at least one support element.

This provides two or more spring-loaded clamping connections arranged next to each other and thus increases the functionality of the conductor connection terminal with improved space utilization. The side-by-side spring-loaded clamping connections can have a common clamping spring, a common busbar and a common support element. However, it is also conceivable that a separate clamping spring, busbar or support element is provided for each spring-loaded clamping connection. In the case of a common support element, two or more spring tongues arranged next to each other may protrude from the support element. The conductor connection terminal can have contact element insertion openings arranged side by side.

The spring tongue can form a jumper connection with the busbar.

This allows for further connection types to be integrated into the conductor connection terminal and the range of application of the conductor connection terminal to be extended. For example, a jumper with two or more plug-in tongues can be inserted in two or more conductor connection terminals having contact element insertion openings lined up with each other.

The conductor connection terminals can comprises a multi-part insulating material housing, wherein a cover part of the multi-part insulating material housing has a receptacle for the support element.

In addition, the cover part of the insulating material housing can have a receptacle for the spring tongue of the support element. The insulating material housing may, for example, have a base housing and a cover part, wherein an opening of the base housing is closed with the cover part. The receptacle for the support element and the spring tongue, for example, are formed by appropriate material recesses, receiving spaces or pockets, wherein recesses can also be formed in the cover part with negative contours corresponding to the outlines of the support element and the spring tongue.

Due to the multi-part design of the insulating material housing, the assembly of the conductor connection terminal can be simplified by, for example, first inserting the internal components of the conductor connection terminal such as the clamping spring, busbar and support element into one part of the insulating material housing and then closing the insulating material housing with the cover part. At the same time, the integrated receptacle for the support element and the spring tongue saves material in the insulating material housing.

The insulating material housing may have a conductor insertion opening to which a conductor insertion channel is attached for the insertion of an electrical conductor to be clamped to the busbar. Furthermore, the insulating material housing may have a contact element insertion opening, to which a contact element insertion channel is connected for the insertion of an electrical contact element to be clamped to the busbar. The conductor insertion opening and the contact element insertion opening are arranged, for example, one above the other. The contact element insertion opening may be located below the conductor insertion opening in relation to a common usage orientation of the conductor connection terminal, where, for example, a bottom of the busbar facing the support element is located below the top of the busbar facing the clamping spring.

The conductor insertion channel and the contact element insertion channel can be arranged on top of each other. The contact element insertion channel can be arranged in relation to a common usage orientation of the conductor connection terminal, where, for example, the bottom of the busbar facing the support element is located below the top of the busbar facing the clamping spring, below the conductor entry channel.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a conductor connection terminal according to the invention in a cut side view;

FIG. 2 shows the conductor connection terminal in a perspective view;

FIG. 3 shows a support element of the conductor connection terminal in a perspective view;

FIG. 4 shows the conductor connection terminal without insulating material housing with a contact element connected to one side, in a perspective side view;

FIG. 5a shows the conductor connection terminal without insulating material housing from FIG. 4 with a contact element connected to one side from a perspective side view opposite the one in FIG. 4;

FIG. 5b shows the conductor connection terminal from FIG. 5a, in a perspective plan view;

FIG. 6a shows the conductor connection terminal without insulating material housing with a contact element to be inserted into the conductor connection terminal, in a side view;

FIG. 6b shows the conductor connection terminal from FIG. 6a with a contact element inserted into the conductor connection terminal, in a side view.

FIG. 7 shows an example of the conductor connection terminal in a cut side view;

FIG. 8a shows an example of a support element of the conductor connection terminal from FIG. 7 in a perspective view;

FIG. 8b shows an example of a busbar of the conductor connection terminal from FIG. 7 in a perspective view;

FIG. 8c shows a connecting element composed of the support element from FIG. 8a and the busbar from FIG. 8b in a perspective view;

FIG. 9a shows an example of a support element in a perspective view;

FIG. 9b shows an example of a busbar in a perspective view;

FIG. 9c shows a connecting element composed of the support element from FIG. 9a and the busbar from FIG. 9b in a perspective view; and

FIG. 9d shows side section view of the connecting element from FIG. 9c.

### DETAILED DESCRIPTION

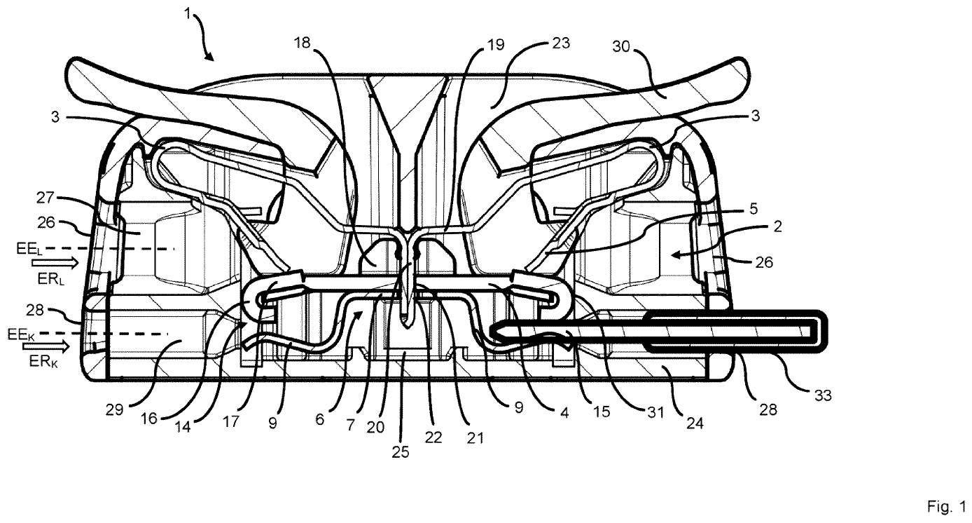

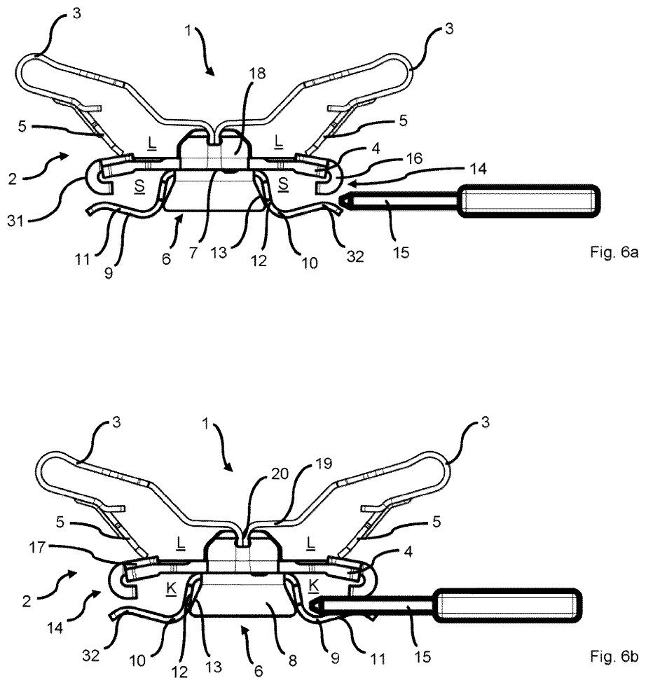

FIG. 1 shows a conductor connection terminal 1 according to the invention with two spring-loaded clamping connections 2 arranged opposite each other. The spring-loaded clamping connections 2 each have a clamping spring 3 and a common busbar 4. By means of a clamping leg 5 of the clamping spring 3, an electrical conductor can be clamped to the busbar 4 at each spring-loaded clamping connection 2 under a spring force of the clamping leg 5. The conductor connection terminal 1 has a support element 6 with a support portion 7, which is arranged adjacent to the busbar 4. The busbar 4 can bear against the support portion 7 of the support element 6 on a side S (see FIG. 6a) remote from the conductor-connection side L (see FIG. 6a).

In the present application, the side of the busbar 4 assigned to the spring-loaded clamping connection 2 may also be referred to as the top of the busbar 4 and the side of the busbar 4 assigned to the support element 6 can also be referred to as the bottom of the busbar 4.

The support element 6 has spring tongues 9 protruding from both sides of the support portion 7, with which an electrical contact element 15, which is designed in the figures as an example of the plug-in tongue of a jumper 33, can be clamped to the busbar under spring force 4. Thus, the spring tongue 9 can form a jumper connection according to the example shown in the figures.

FIG. 3 shows the support element 6 in a perspective view. The support portion 7 of the support element 6 and the spring tongues 9 of the support element 6 protruding from the support portion 7 can be seen. The spring tongue 9 is an elastically movable, flap-shaped spring element. In this case, each spring tongue 9 protrudes under a bend from the support portion 7 and transitions into an bearing section 12, with which the spring tongue 9 can rest or be supported against a bearing surface 13 of a side section 8 bent away from the support portion 7. The support element 7 can also have two opposite side sections 8 bent away from the support portion 7 in order to enable symmetrical bearing of the spring tongue 9. The bearing section 12 forms a stop for the inserted contact element 15, as can be seen for example from FIG. 1. The bearing section 12 of the spring tongue 9 transitions into a resilient bend 10 of the spring tongue 9, with which the spring tongue 9 changes the direction of its main extension and now tilts towards the busbar 4 and runs in the opposite direction of insertion ER_{K} of the contact element 15 shown in FIG. 1. On the side of the resilient bend 10 remote from the bearing section 12, the resilient bend 10 transitions into a clamping arm 11 with which the contact element 15 can be pressed against the busbar 4 under the spring force of the clamping arm 11. In an end area 32 of the clamping arm 11, the spring tongue 9 is again bent away from the busbar 4 to facilitate the insertion of the contact element 15 into the conductor connection terminal 1. Starting from the connecting point to the support portion 7 of the support element 6, the spring tongue 9 is first convex, then concave and finally convex again. The spring tongue 9 thus has two consecutive S-shaped bends, wherein in each case an S-bend is formed by the resilient bend 10.

As can be seen in FIG. 3, the support element 6 is designed in one piece and has a side section 8 bent away from the support portion 7 and spring tongues 9. In addition, the support element 6 has a recess 22 in the support portion 7 in which an end segment 20 of the bearing leg 19 of the clamping spring 3 can be received. The recess 22 can have a T-shape to provide a locking of the end segments 20 of the bearing legs 19 of the clamping springs. For example, the end segments 20 can initially reach through the opening 21 in the busbar 4 and the recess 22 of the support element 6 in the wider crossbar area of the T-shape. By moving the support element 6 in the direction of the conductor insertion EE_{L}, the end segments 20 can be moved into the narrower base line or trunk area of the T-shape so that the end segments 20 are defined in the T-shape of the recess 22. In this case, a corresponding tapering of the end segments 20 at the level of the recess 22 may be provided for easier guidance.

As can be seen in FIG. 1, among other things, the busbar 4 is one-piece and beam-shaped and has a busbar bend 16 at each of its end sections 14, with which the busbar 4 is bent by about 180°. This way, the contact element 15 in the example shown is clamped to the conductor 4 on a side S of the busbar 4 which is remote from the conductor-connection side L, but on the same clamping surface 31 of the busbar 4 as the electrical conductor to be clamped to the busbar 4. In addition, the distance between the spring tongue 9 and the busbar 4 is reduced by the busbar bend 16.

The busbar 4 also has a inclined section in the area of the clamping point with the clamping leg 5 of the clamping spring 3, which is hereinafter referred to as the busbar inclination 17. The busbar inclination 17 transitions on one side into the busbar bend 16 and on the side remote from the busbar bend 16, the busbar inclination 17 partially protrudes beyond the busbar 4 plane or is reinforced. This protruding edge forms a clamping point for the electrical conductor on the busbar 4. The busbar 4 has an opening 21 through which a bearing leg 19 of the clamping spring 3 protrudes with an end segment 20 and ends in a recess 22 of the support element 6. This allows for the bearing leg 19 of the clamping spring 3 to be used to center, fix and stabilize the components of the conductor connection terminal 1.

The conductor connection terminal 1 shown in FIG. 1 has an insulated material housing 23, which protects the spring-loaded clamping connections 2 and the connections for clamping the contact element 15 from environmental influences and contact. The insulating material housing 23 has a multi-part structure and has a cover part 24 with which the insulating material housing 23 can be closed after the assembly and arrangement of the clamping spring 3, the busbar 4 and the support element 6 in the insulating material housing 23. The cover part 24 has a receptacle 25 for the support element 6.

The insulating material housing 23 has a conductor insertion opening 26, which transitions into a conductor insertion channel 27. An electrical conductor can be inserted into the conductor insertion channel 27 in a conductor insertion direction ER_{L} and routed to the spring-loaded clamping connection 2 in order to be clamped to the busbar 4 with the clamping leg 5 of the clamping spring 3.

The insulating material housing 23 also has a contact element insertion opening 28, which transitions into a contact element insertion channel 29. An electric contact element 15 can be inserted into the contact element insertion channel 29 in a contact element insertion direction ER_{K} and guided to the spring tongue 9 of the support element 6 in order to be clamped to the busbar 4 with the spring tongue 9.

As shown in FIG. 1, a plug-in plane EE_{L} of an electrical conductor to be clamped to the busbar 4 runs essentially parallel to a plug-in plane EE_{K} of the contact element 15 to be clamped to the busbar 4. The contact element 15 and an electrical conductor can thus be inserted into the conductor connection terminal 1 in essentially parallel planes EE_{L}, EE_{K}. The plug-in direction ER_{L} of a conductor to be plugged in and the plug-in direction ER_{K} of a contact element 15 to be inserted are aligned with regard to a spring-loaded clamping connection 2 and a spring tongue 9 arranged below the spring-loaded clamping connection 2.

In the insulated material housing 23 there are also two operating levers 30, each of which is assigned to a spring-loaded clamping connection 2 and facilitates the operation of the spring-loaded clamping connection 2.

The conductor connection terminal 1 shown in FIG. 1 is designed as a double connection with two conductor insertion openings 26 opposite each other and two opposite contact element insertion openings 28. As a result, electrical conductors from two opposite sides can be inserted in the conductor connection terminal 1 in opposite insertion directions ER_{L}, as well as electrical contact elements 15 from two opposite sides in opposite insertion directions ER_{K}. The conductor connection terminal 1 as shown in FIG. 1 is essentially symmetrically constructed, wherein an assigned axis of symmetry runs between the end segments 20 of the bearing legs 19 of the clamping springs 3.

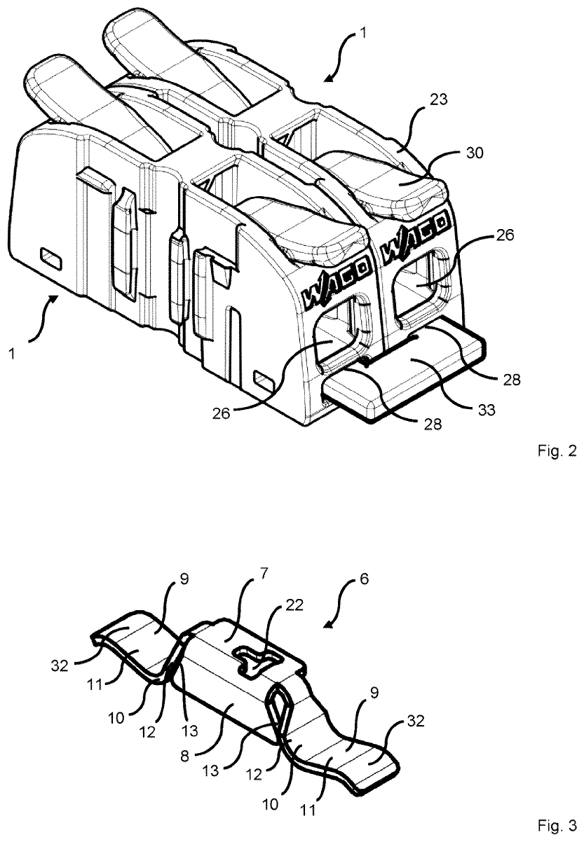

FIG. 2 shows the conductor connection terminal 1 with to the insulating material housing 23 in a perspective view. It can be seen that the conductor connection terminal 1 is designed as a double connection, as can be deduced from the two opposing operating levers 30 of the conductor connection terminal 1. In addition, two comparably designed conductor connection terminals 1 are arranged next to each other in series. On the side of the conductor connection terminals 1 visible in FIG. 2, they each have a conductor insertion opening 26 and a contact element insertion opening 28, into each of which a plug-in tongue of a jumper 33, which is not visible in FIG. 2, is inserted. According to the illustration in FIG. 2, the contact element insertion opening 28 is located below the conductor insertion opening 26.

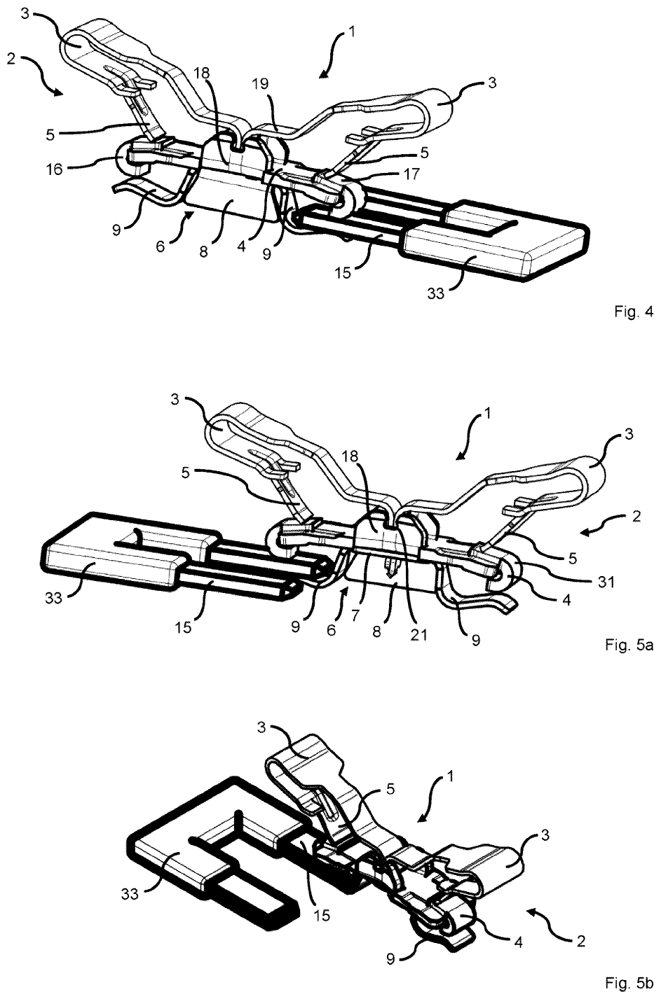

FIGS. 4, 5a and 5b show the conductor connection terminal 1 without the insulating material housing. In these figures it can be seen that the busbar 4 has bent side plates 18, between each of which a bearing leg 19 of the clamping springs 3 is routed, increasing the stability of the conductor connection terminal 1. Furthermore, it can be seen how a contact element 15, which is designed as the plug-in tongue of a jumper 33, is clamped against the busbar 4 by the spring force of the spring tongue 9.

In FIGS. 6a and 6b, an electrical contact element 15 is shown before and after its insertion into the conductor connection terminal 1. According to the illustration in FIG. 6a, the side of the busbar 4, which is facing the clamping spring 3 for the connection of an electrical conductor, is called the conductor-connection side L. The support element 6 is arranged on the side S of the busbar 4 remote from the conductor-connection side L. According to the illustration in FIG. 6b, the contact element 15 is clamped on a contact-connection side K of the busbar 4, which in the example shown in the figures coincides with the side S of the busbar 4 remote from the conductor connection side L. In principle, depending on the design of the spring tongue 9, designs are also conceivable in which the contact-connection side K is on another side of the busbar 4, for example on the conductor-connection side L or on a front side of the busbar 4. The conductor-connection side L can also be referred to as the top of the busbar 4 in reference to a common usage orientation of the conductor connection terminal 1, while the side S remote from the conductor-connection side L of the busbar can also be referred to as the bottom of the busbar 4.

The inventive conductor connection terminal 1 provides a particularly versatile, compact conductor connection terminal that has been improved in terms of its functionality. The conductor connection terminal 1 has an additional connection option for electrical contact elements 15 without the need for a separate connection component or for increasing the installation space of the conductor connection terminal 1.

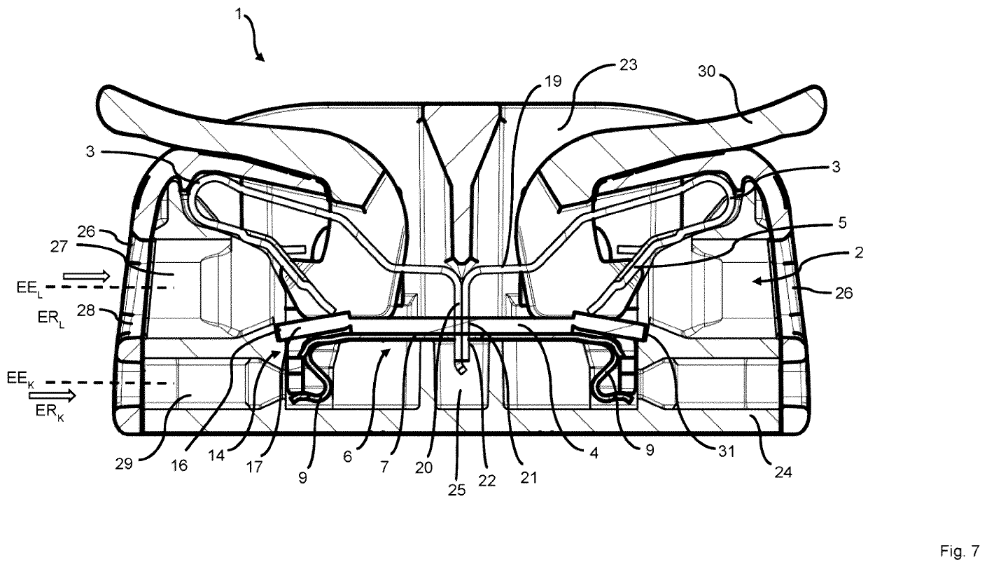

FIG. 7 shows a different example of the conductor connection terminal 1 from FIG. 1. Again, there are two spring-loaded clamping connections 2 arranged opposite each other with a clamping spring 3 each and a common busbar 4. By means of a clamping leg 5 of the clamping spring 3, an electrical conductor can be clamped to the busbar 4 at each spring-loaded clamping connection 2 with the help of the spring force of the clamping leg 5. The structure of the conductor connection terminal 1, in particular the insulating material housing 23 with the operating levers 30, is explained in FIG. 1.

The conductor connection terminal 1 has a support element 6 which is modified as compared to the first example and has a support portion 7, which is arranged adjacent to the also modified busbar 4. The support element 6 together with the busbar 4 forms a connection element.

The support element 6 rests with its support portion 7 on the bottom of the busbar 4. In the support portion 7 there is a recess 22 and in the busbar 4 an opening 21 aligned with it in order to receive the end segments 20 of the bearing legs 19 of the clamping springs 3.

The busbar 4 has end walls 34 at its ends that are bent away from the support plane for the support portion 7 in a direction pointing away from the clamping spring 3. A bend can also be realized by an angled section. The support element 6 has opposing S-shaped curved spring tongues 9, which with their end area 32 bear on a lower edge of an end wall 34 of the busbar 4. A contact element 15 inserted into a contact element insertion channel 29 is then clamped by the spring-elastic end area 32 of the spring tongue 9 of the support element 6 between the end area 32 and the inner surface of a recess 35 in the end wall 34.

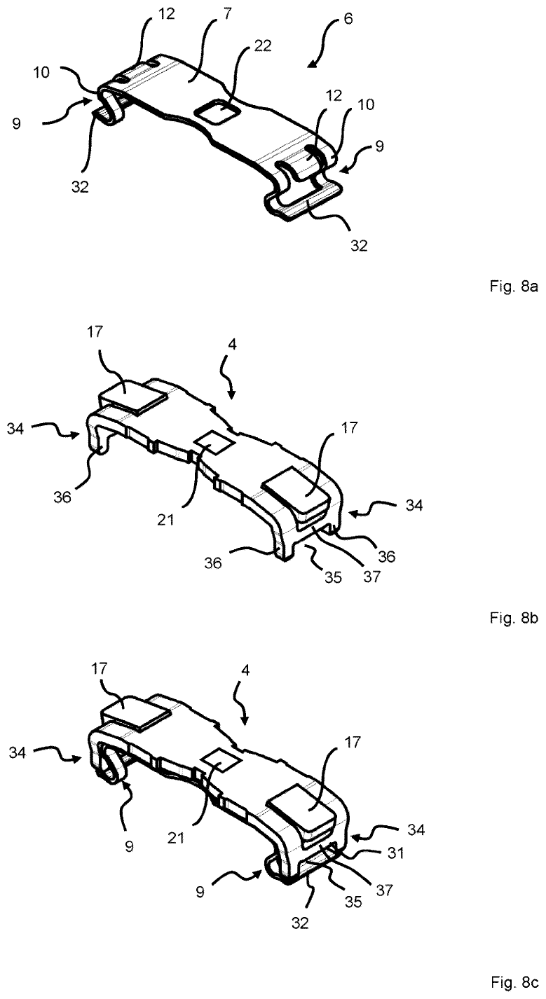

FIG. 8a shows a perspective view of the support element 6 of the conductor connection terminal 1 from FIG. 7. It can be seen that the support element 6, for example, has a recess 22 centrally in the support portion 7. From the support portion 7, bearing sections 12 protrude in diametrically opposed directions. These may be designed in the form of material tongues bent from the plane of the support portion 7 towards the adjacent end area 32. With the help of these bearing sections 12, the support element 6 can be clamped into the receiving space of the busbar 4, which is limited by the end walls 34. For this purpose, the bearing sections 12 are adjacent to the opposing inner sides of the end walls 34. Due to the spring elasticity of the bearing sections 12, clamping forces act on both sides on the opposing end walls 34, which tension the support element 6 on the busbar 4.

In the root area, where in each case a bearing section 12 is relieved from the support portion 7, a spring tongue 9 is bent with two bars spaced apart. Between the bars of the spring tongue 9 is the bearing section 12. The spring tongue has an S-shaped resilient bend 10, which ends with the end area 32 of the support element 6.

FIG. 8b shows an example of the busbar 4 in a perspective view. It can be seen that the busbar 4 has busbar inclinations 17 on the upper level that both face away from each other. These are used to guide an electrical conductor to the clamping point. In the area of these partially relieved busbar inclinations 17, an end wall 34 protrudes in each case, which at the lower end has a recess 35, which is bounded by two posts 36 spaced from each other. Between the recess 35 and the busbar inclination 17 there may be a crossbar 37 connecting the posts 36. A recess is formed between the busbar inclination 17 and the crossbar 37, into which the bearing sections 12 of the support element 6 can also be hooked in as an alternative to clamping.

FIG. 8c shows the connecting element formed from the support element 6 and the busbar 4. It can be seen that the lower end face of the crossbar 37 forms the clamping surface 31 of the busbar 4 for the clamping of a contact element 15. The end area 32 of the spring tongue 9 is used for clamping a contact element 15 between the end area 32 and the clamping surface 31. The end area 32 with its edge areas is also supported on the lower end surfaces of posts 36 or edge bars bordering the recess 35 in the end wall 34.

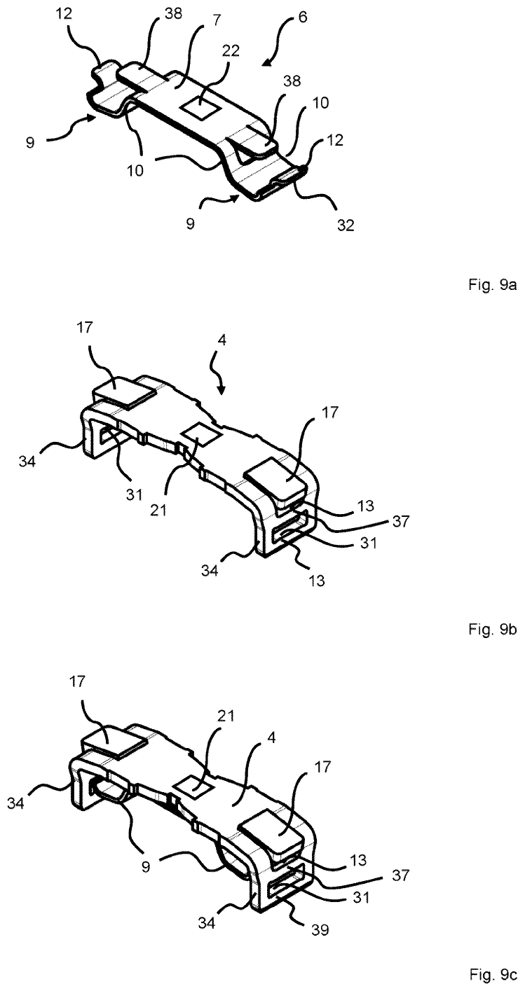

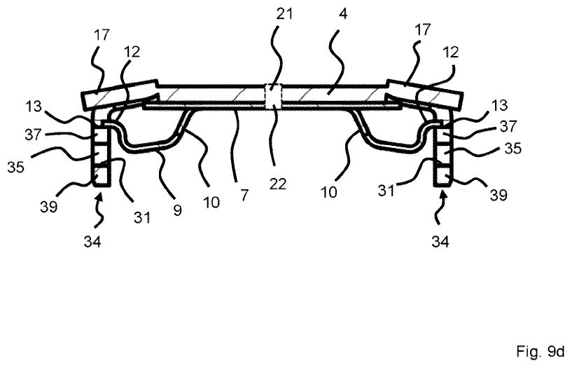

FIG. 9a shows another variant of the support element 6, which in turn has a support portion 7. From the support portion 7, material tongues 38 protrude on both sides in opposite directions, which material tongues rest below the busbar inclinations 17. Next to each material tongue 38, a spring tongue 9 is bent away with two spaced edge bars. The material tongue 38 is positioned between the edge bars of the spring tongue 9. The spring tongue 9 and the material tongue 38 are connected to the support portion 7 in a common root area.

The spring tongue 9 is bent U-shaped from the plane of the support portion 7 with a resilient bend 10. The end section 32 forms a bearing section 12. This can be tapered.

FIG. 9b shows a variant of the busbar 4, which has end walls 34 bent from the plane with the busbar inclinations 17. The end walls 34 each have a recess 35 for inserting a contact element 15. The recess 35 is bounded by an upper crossbar 37 and a lower crossbar 39. The upper end surface of the upper crossbar 37, which faces the busbar inclination 17, forms a bearing surface 13 for the bearing section 12 at the end area 32 of the support element 6. The upper end surface of the lower crossbar 39 forms a clamping surface 31 of the busbar 4 for clamping a clamping element 15 between the clamping surface and the bottom of the resilient bend 10.

FIG. 9c shows a connecting element formed from the support element 6 and the busbar 4 in the perspective view and FIG. 9d in the side section view.

It can be seen that the support element 6 is clamped in the busbar 4 by the spring-elastic material tongue 38 and the bearing section 12 of the spring tongue 9. The bearing section 12 may in turn be hooked into the recess formed between the busbar inclination 17 and the upper crossbar 37.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A conductor connection terminal comprising:
a spring-loaded clamping connection comprising a busbar and a clamping spring having a clamping leg, an electrical conductor being adapted to be clamped under spring force to a conductor-connection side of the busbar via the clamping leg of the clamping spring;
a support element comprising a support portion for bearing against a side of the busbar, which side is remote from the conductor-connection side; and
two spring-loaded clamping connections arranged opposite one another, each having a clamping spring, a common busbar, and a common support element,
wherein the support portion contacts the busbar at least in sections over its entire surface,
wherein the support element has spring tongues, with which the electrical contact element is adapted to clamped to the busbar under spring force, and
wherein the spring tongues are formed in one piece with the support element, adjoin the support portion, and project from the support portion on opposite sides of the support element.

2. The conductor connection terminal according to claim 1, wherein the spring tongue has a resilient bend from which a clamping arm protrudes for clamping the contact element.

3. The conductor connection terminal according to claim 1, wherein the spring tongue is bent in an S-shape, at least in sections.

4. A conductor connection terminal comprising:
a spring-loaded clamping connection comprising a busbar and a clamping spring having a clamping leg, an electrical conductor being adapted to be clamped to a conductor-connection side of the busbar under spring force via the clamping leg of the clamping spring; and
a support element comprising a support portion for bearing against a side of the busbar which is remote from the conductor-connection side, the support element having a spring tongue with which the electrical contact element is adapted to be clamped to the busbar under spring force,
wherein the spring tongue is formed in one piece with the support element, adjoins the support portion, and is bent in an S-shape at least in sections and ends with an end region of the support element,
wherein the busbar is bent over in an end section of the busbar in a direction of the spring tongue and has an end wall bent in a direction pointing away from the clamping spring, and
wherein the spring tongue rests with its end region on a lower edge of the end wall of the bent-over end section of the busbar.

5. The conductor connection terminal according to claim 1, wherein the electrical contact element is adapted to be clamped to the busbar on a contact connection side which is remote from the conductor-connection side.

6. The conductor connection terminal according to claim 1, wherein the spring tongue extends starting from the support element essentially in the opposite direction to the plug-in direction of the electrical contact element to be clamped to the busbar.

7. The conductor connection terminal according to claim 1, wherein the plug-in plane of an electrical conductor that is adapted to be clamped to the busbar extends essentially parallel to the plug-in plane of a contact element that is adapted to be clamped to the busbar.

8. The conductor connection terminal according to claim 1, wherein spring-elastic bearing sections project from the support portion in diametrically opposite directions, which are designed in the form of material tongues and tension the support element against the busbar.

9. The conductor connection terminal according to claim 1, wherein the spring tongue has a bearing section for the bearing of the spring tongue against a side section of the support element.

10. The conductor connection terminal according to claim 9, wherein the bearing section forms a stop to limit the insertion depth of the electrical contact element.

11. The conductor connection terminal according to claim 1, wherein the busbar in an end section of the busbar is bent in the direction of the spring tongue.

12. The conductor connection terminal according to claim 1, wherein a bearing leg of the clamping spring protrudes with an end segment into or through an opening in the busbar.

13. The conductor connection terminal according to claim 1, wherein the conductor connection terminal is designed as a double or multiple connection having at least two conductor insertion openings opposing each other and having at least two clamping springs, at least one busbar, and at least one support element.

14. The conductor connection terminal according to claim 1, wherein the conductor connection terminal is designed as a double or multiple series terminal having at least two conductor insertion openings arranged next to each other and having at least one clamping spring, at least one busbar, and at least one support element.

15. The conductor connection terminal according to claim 1, wherein the spring tongue forms a jumper connection with the busbar.

16. The conductor connection terminal according to claim 1, wherein the conductor connection terminal has a multi-part insulating material housing, wherein a cover part of the multi-part insulating material housing has a receptacle for the support element.
